(19) United States
(12) Patent Application Publication
(10) Pub. No.: US 2025/0343751 A1
(43) Pub. Date: Nov. 6, 2025

(54) AUTOCONFIGURATION PROTOCOL FOR IN-NETWORK COLLECTIVE COMMUNICATION

(71) Applicant: Intel Corporation, Santa Clara, CA (US)

(72) Inventors: Przemyslaw R. KARPINSKI, Gdansk (PL); Robert BENKE, Sopot (PL); Marek M. LANDOWSKI, Gdansk (PL); Maciej GRZYWACZ, Gdansk (PL)

(21) Appl. No.: 19/266,039

(22) Filed: Jul. 10, 2025

(51) Int. Cl. H04L 45/12; H04L 49/109

(52) U.S. Cl. CPC H04L 45/12; H04L 49/109

(57) ABSTRACT

Examples described herein relate to configuring a shortest route from a root switch to one or more terminal switches of a network by: the root switch causing: identification of switches of the network as one of: a terminal switch, a forwarding switch, or a root switch, wherein: the terminal switch is connected to a processor and the processor is to process collective communications. Configuring the shortest route from the root switch to one or more terminal switches of the network can include causing ports of the switches of the network to identify a connection to another port as one of: connection to a terminal switch; connection to a forwarding switch; connection to a root switch; and not connected to a terminal switch, root switch, and a forwarding switch.

As multi-processor systems increase in scale, communication between processors becomes a factor in overall application performance. Additionally, the ability for a single core in a system to efficiently send messages to others via a broadcast (one-to-all) or multicast (one-to-n) implementation is a feature in scaled systems. Broadcast and multicast are communication patterns that apply to different programming abstractions and models, which makes them applicable to a wide range of use-cases. For example, fork-join, data-flow, and bulk synchronous models can utilize broadcast and multicast implementations.

Collective Communication (CC) is a class of distributed system synchronization primitives. High performance computing (HPC), autonomous vehicles/robotics, edge/Internet of Things (IOT) solutions, and training and inference of artificial intelligence (AI) and machine learning (ML) workloads use CC primitives, especially in the context of model parameter reductions in data-parallel training and activation calculations during various types of distributed inference.

### BRIEF DESCRIPTION OF THE DRAWINGS

FIG. 1 depicts an example Programmable and Integrated Unified Memory Architecture (PIUMA) die.

FIG. 2 shows a logical block diagram of a switch.

FIG. 3 shows an example of core organization.

FIG. 4 shows an example of internal organization of a core collective engine.

FIG. 5 shows an example of message traversal.

FIG. 6A depicts an example circuitry of a switch.

FIG. 6B depicts an example circuitry in a switch.

FIG. 7 depicts an example of topology discovery.

FIG. 8A depicts an example process.

FIG. 8B depicts an example process.

FIG. 9 depicts an example system.

### DETAILED DESCRIPTION

Some examples provide an approach to executing multicast and broadcast operations in a scalable system using a network of configurable switches. Some examples utilize particular instruction set architecture (ISA) extensions as well as hardware to support interrupt generation and handling of data receipt and processing for multicast or broadcast operations. Using configurable switches in a scalable architecture allows for potential to improve performance of a multicast to cores in a system.

Some examples provide instructions that allow programmers and workload owners to cause a core to place one or more packets or data into a network and propagate the one or more packets or data to N number of other nodes or cores, where N is 2 or more. Receiving nodes or cores can receive the packet or data and interrupt a thread on a core to fetch packet or data from a queue and the packet or data into another location. Reference to a core herein can refer to a core, processor, accelerator, or other device.

Some examples can utilize configurability of collective virtual circuits (VCs) in the network switches. In some examples, this configurability is implemented as per-port register descriptions that specify the direction in which data is to be received or transmitted for one or more ports. Switches can be configured using bit vectors to indicate a direction a port is to receive or transmit data within a tile or between tiles.

Some examples can be used with the Intel® Programmable and Integrated Unified Memory Architecture (PIUMA), although examples can apply to other architectures such as NVIDIA, Graphcore, Cray Graph Engine, Intel's Ultra Path Interconnect (UPI), Compute Express Link (CXL), or Nvidia's NVLINK.

Various protocols can be utilized to exchange data and results among processes running on different nodes. Processes can use a class of operations called collectives to enable communication and synchronization between multiple processes on multiple nodes. Message Passing Interface (MPI), Symmetric Hierarchical Memory Access (SHMEM), and Unified Parallel C (UPC) are some example protocols. Some examples provide a selection of aggregation tree topologies that uses a distributed physical point-to-point messaging for communication at least of collectives. One or more switches can identify ports of switches as connected to a root port, a terminal, a forwarding switch, or none. For example, one or more switches can detect terminal and forwarding switches and prune switches that do not form a path between root and terminal switches by application of Steiner Arborescence (SA) techniques.

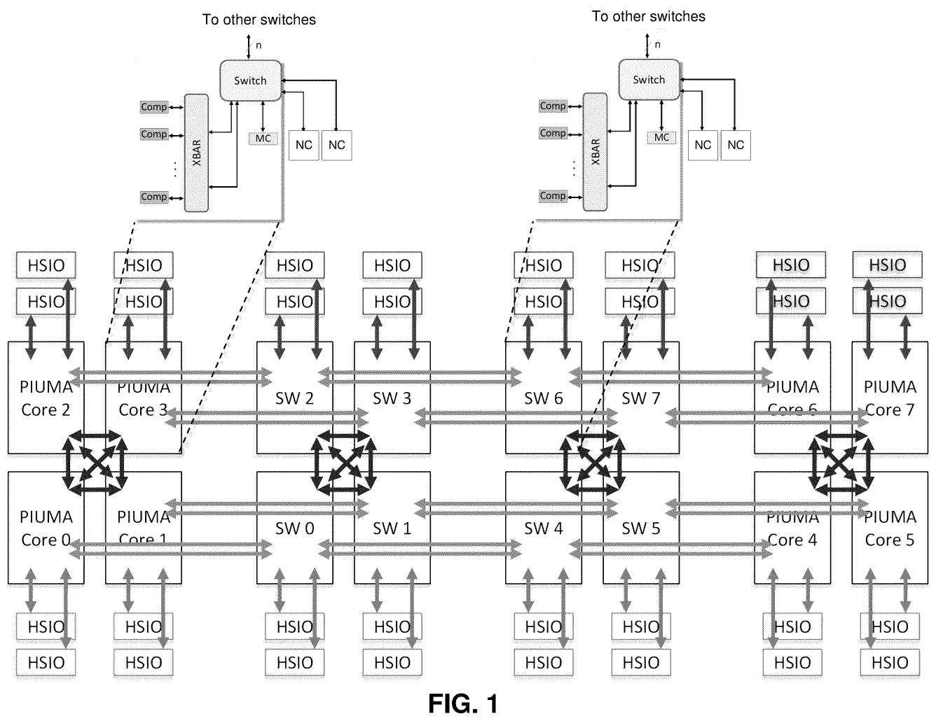

FIG. 1 depicts a die that can include eight cores (cores 0 to 7). A core can include a crossbar (XBAR) that communicatively couples compute elements (Comp) to a switch. A core switch can interface with a memory controller (MC), another core switch, a switch, and/or network components (NC). A die can include eight network switches (SW0 to SW7) (referred to as peripheral switches) and 32 high-speed I/O (HSIO) ports for inter-die connectivity. SW0 to SW7 can form a network on chip (NoC) or a network in one or more packages. Beyond a single die, system configurations can scale to multitudes of nodes with a hierarchy defined as 16 die per subnode and two subnodes per node. Network switches can include support for configurable collective communication. In some examples, a die can include one or more core tiles and one or more switch tiles. In some examples, 4 cores can be arranged in a tile; 4 switches can be arranged in a tile; 4 tiles can be arranged in a die; and 32 die can part of a node. However, other numbers of cores and switches can be part of a tile, other numbers of tiles can be part of a die, and other numbers of die can be part of a node.

As described herein, switches SW0 to SW7 can detect terminal and forwarding switches by application of Steiner Arborescence (SA) techniques to construct a minimum spanning tree over the network and prune branches that do not lead to terminal nodes (e.g., switches connected to processor cores).

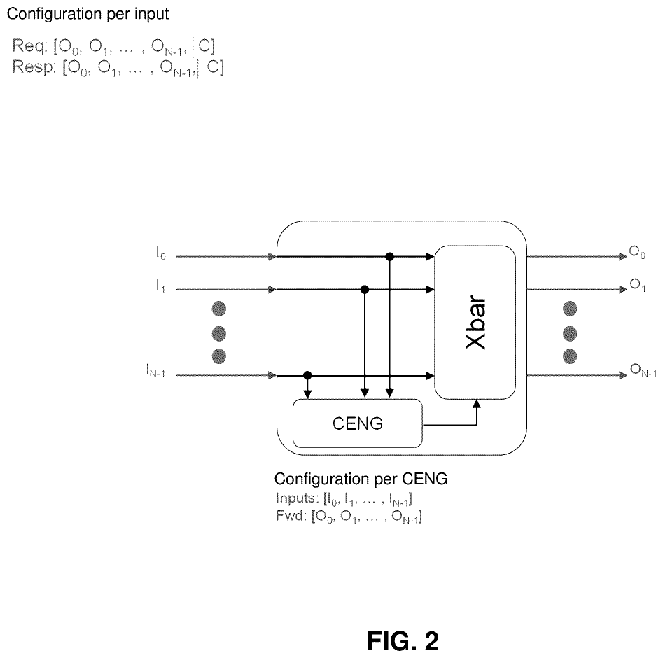

FIG. 2 shows a logical block diagram of a switch with N ports. A collective engine (CENG) can be used to support in-switch compute capability for reductions and prefix scans. For in-network reductions and prefix scans, at least one input port of the switch (I₀ to I_{N-1}) can include two sets of configuration registers, namely, a request (Req) configuration register for the forward path of a reduction or prefix-scan operation and a Response (Resp) configuration register for the reverse path or a reduction or prefix-scan. The request configuration register can be used for some multicast examples described herein.

CENG performs collective operations such as thread barriers and reduction operations. A network-on-Chip (NoC) switch includes an arithmetic unit capable of reducing incoming data.

A per-port request configuration register, described herein, can store a bit vector which represents which output ports (O₀ to O_{N-1}) data from an input port is forwarded-to. Additionally, an indicator (e.g., bit) can be included to indicate if the input port is sending its value to the switch's collective engine for reductions and prefix-scans. For multicasts and broadcasts, this bit can be set to 0. For an operation type, a bit vector could be set to all 0s.

Some examples can include ISA extensions and core architecture modifications for multicasting a message throughout a system using a single instruction. Some examples can include architecture modifications to allow for interrupt generation and storage of received multicast messages to attempt to prevent participating cores having to condition the local engine to receive expected multicast messages. Some examples can include the use of a configurable in-network switch tree to allow for a single message to take the shortest path (e.g., fewest number of core or switch node traversals) when propagating data to the desired cores in the system.

### ISA Support Multicasts in the System

In some examples, the PIUMA ISA includes instructions specific to the multicast capability. Examples of these instructions are shown in Table 1 and can be issued by a multi-threaded pipeline (MTP) or single-threaded pipeline (STP) in a core.

TABLE 1
mcast.{send/poll/wait} instruction definitions.

| | ASM Form | |
|---|---|---|
| Instruction | Arguments | Argument Descriptions |
| mcast.send | r1, r2, r3, SIZE | r1 = mcast tree ID; r2.SIZE = Data value to send; r3 = ID |
| | | value of sending thread |
| mcast.poll | r1, r2, r3, r4 | r1 = Status of mcast.read; r2 = data value; r3 = ID value of |
| | | thread that sent data; r4 = mcast tree ID |
| mcast.wait | r1, r2, r3, SIZE | r1.SIZE = data value; r2 = ID value of thread that sent |
| | | data; r3 = mcast tree ID |

Instruction mcast.send can be issued by a data-sending thread. When a thread executes instruction mcast.send, it sends data and identifier to be multi-casted over the network. Because multiple connectivity configurations are supported, the instruction includes a value specifying the configured network tree identifier (ID). For example, a thread executing on a core can send a value with thread ID using configuration on a network (tree). The configuration can be set prior to the sending of the value in some examples. A developer can specify r1 to set configuration values for nodes to use to receive and transmit data to recipients on a path towards terminals.

Instruction mcast.poll can be issued by a thread in a receiving core. Execution of instruction mcast.poll can cause fetching of an oldest received multicast (mcast) message currently residing in its local queue (e.g., mcast queue) and return the data and thread ID associated with the data. Instruction mcast.poll can be non-blocking to the issuing thread and can return a fail status if there were no messages waiting in the mcast queue. A receiving core can execute multiple threads and a specific thread can poll a receive queue to check if a value was received in a non-blocking manner. The specific instruction mcast.poll can return a status and value.

Instruction mcast.wait can be issued by a thread in a receiving core. Instruction mcast.wait can perform similar operations as that of instruction mcast.poll, except that it is blocking to the issuing thread, e.g., it will not allow forward progress of the issuing thread until it returns valid data from the mcast queue. If there is no data in the mcast queue when the instruction is issued, it will wait until data is available. A receiver thread can wait to receive data before proceeding with execution.

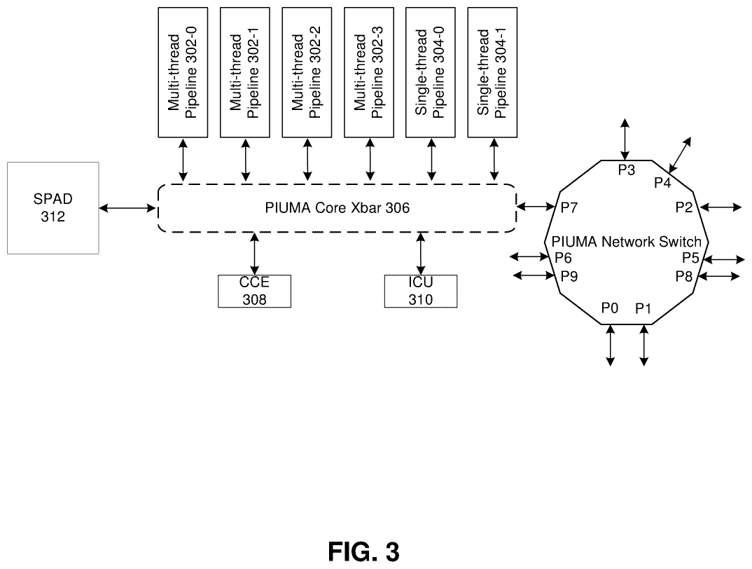

Various example operations of a core to support the multicast functionality of sending and receiving messages are described next. FIG. 3 shows an example of core organization. In this example, six pipelines (e.g., MTP 302-0 to 302-3 and STP 304-0 to 304-1) can be connected with a core collective engine (CCE) 308 through a crossbar 306. Additionally, FIG. 3 shows the local core interrupt controller unit (ICU) 310, core-local scratchpad (SPAD) memory 312, and one or more ports of the core's network switch (e.g., P7).

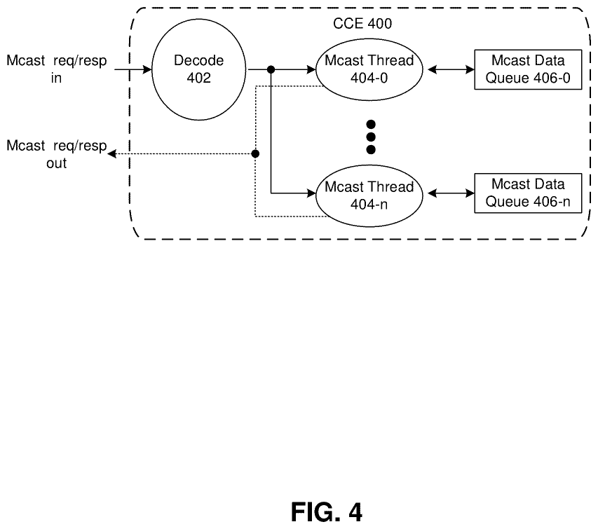

FIG. 4 shows an example of internal organization of a CCE. Instructions are received from the PIUMA core crossbar (xbar) port, decoded by decoder 402, and sent to the proper mcast thread (e.g., one or more of Mcast threads 404-0 to 404-n) managing the collective ID targeted by the received mcast.*instruction. A thread can include a data queue (e.g., one or more of Mcast data queues 406-0 to 406-n) with a slot holding the data and identifier received as the result of a multicast. A receiver can access a queue for a particular network or tree configuration. A thread can be interrupted when the queue is full or data is received.

Mcast.send instructions issued from a pipeline in the core can be sent to a local core CCE 400. At CCE 400, the request can be assigned to a proper mcast thread (e.g., one or more of Mcast thread 404-0 to 404-n) associated with the received collective ID. The mcast thread can copy or move the data and identifier, included in the instruction request, into its data queue (e.g., Mcast data queue 405-0 to 406-n). The data and identifier can be sent out to the local network switch to be propagated across a collective tree or network path that includes multiple core and/or switch nodes. The message can include the collective ID to reference the proper switch configuration.

At a point, CCE 400 may receive a message from the local network switch as a result of a multicast from a remote core. This message can be a unique request which includes the collective ID, data, and identifier. After receipt, CCE 400 can identify the target mcast thread ID and push the data and identifier onto its associated queue. After data occupies the CCE's mcast queue, the queue status can be exposed to the local core's threads using one or more of the following technologies: PUSH or POLL.

For a PUSH (interrupt), CCE 400 can trigger an interrupt via a local core's ICU that can launch on at least one of the local core's STPs. This interrupt routine can inspect the status of the mcast data queues (e.g., via the registers described in Table 2), access data on the queue, and store the data in the core's local memory or cache for the local threads to access.

For a POLL operation, one or more of the local core's threads can consistently poll the CCE mcast threads for messages that have been received from remote mcast operations, such as by looping on the mcast.poll instruction and placing data received from successful poll requests into a local memory or cache. A mcast.poll that is successful can remove the returned message from the mcast ID's data queue.

One, a strict subset, or all of mcast queues 406-0 to 406-n can include a set of machine specific registers (MSRs) that are visible and accessible in the address map and accessible by software. An example of MSRs, as listed in Table 2, can provide control of interrupt-generating events in the queue and to give queue status visibility to the interrupt handler.

TABLE 2
Core collective engine MSR entries that exist for each multicast ID

| | | Software read |
|---|---|---|
| Name | Description | (R)/ write (W) |
| MODE | Push-mode or poll-mode. | R/W |
| COUNT | Current number of messages occupying the | R |
| | queue. | |
| INT_ALL | Send an interrupt every time a message is | R/W |
| | added to the queue. | |
| INT_EMPTY_2_NEMPTY | If not interrupting on every message received, | R/W |
| | interrupt when queue goes from empty to not- | |
| | empty. | |
| INT_NFULL_2_FULL | If not interrupting on every message received, | R/W |
| | interrupt when queue goes from not full to | |
| | full. | |

In addition to the core architectural modifications to send a multicast packet into the network, the switch port request configuration registers can be set to support multicast.

Note that the architecture of the switch collectives may not change to support the multicast, however, the implementation of the multicast can vary from the reductions and barriers in the following ways. The multicast has a forward phase through the network and reductions/barriers have both a forward (up-tree) and reverse (down-tree) phases through the network. The multicast implementation can cause switches to send request packets to each CCE (e.g., the CCE is not conditioned to expect the request before it arrives). In reductions and barriers, these packet types were responses which the CCE was expecting. The connectivity of the switches can allow for a full propagation of the message through the network (e.g., 1-to-many ports), rather than k-ary tree connectivity restriction that the reductions and barriers follow.

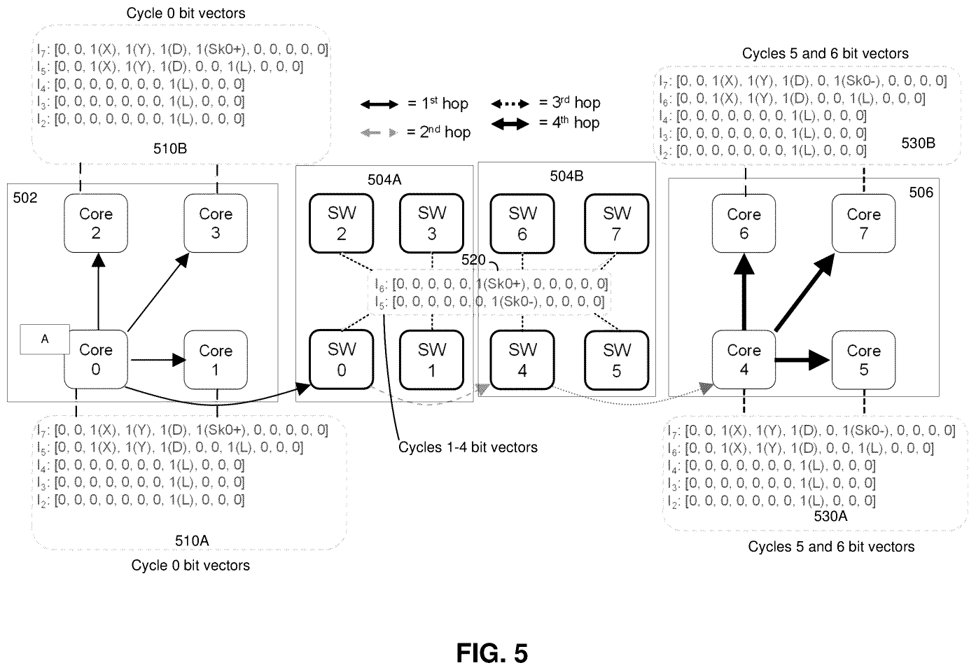

FIG. 5 shows an example of message traversal. In this example, configuration values for a multicast implementation between eight cores in a single die are set as shown in FIG. 5. For the purposes of this example, the system on chip (SoC) topology shown in FIG. 1 can be used.

TABLE 3
Switch port numbering used for example in FIG. 5

| | | Reference to example of |
|---|---|---|
| PORT | DESCRIPTION | FIG. 5 |
| 0 | HSIO port 0 to transmit off die | Not used in example of |
| | | FIG. 5 |
| 1 | HSIO port 1 to transmit off die | Not used in example of |
| | | FIG. 5 |
| 2 | Intra-tile X-axis dimension | Notated as X in FIG. 5 |
| 3 | Intra-tile Y-axis dimension | Notated as Y in FIG. 5 |
| 4 | Intra-tile diagonal dimension | Notated as D in FIG. 5 |
| 5 | Inter-tile positive X-axis | Notated as Sk0+ in FIG. 5 |
| | direction through port 0 | |
| 6 | Inter-tile negative X-axis | Notated as Sk0- in FIG. 5 |
| | direction through port 0 | |
| 7 | Execution of Mcast.send causes | Notated as L in FIG. 5 |
| | CCE to transmit data (Local | |
| | port). | |
| 8 | Inter-tile positive X-axis | Not used in example of |
| | direction on port 1. | FIG. 5 |
| 9 | Inter-tile negative X-axis | Not used in example of |
| | direction on port 1. | FIG. 5 |
| 10 | Send/Receive data to/from | Not used in example of |
| | Switch Collective Engine | FIG. 5 |

Configurations or bit vectors 510A, 510B, 520, 530A, and 530B can be defined using the scheme of Table 3 to indicate direction of data transit from a switch for a 4 tile environment where a direction is either (+) or (−) direction. As shown in FIG. 5, configurations or bitmaps 510A, 510B, 520, 530A, and 530B can be defined as 11 bit vectors corresponding to respective PORT 0 to 10 in Table 3. Configurations I₀, I₁, I₆, I₈, I₉, and I₁₀, are not used in the example of FIG. 5.

Ports of cores 0 and 1 in tile 502 can be configured using configuration 510A whereas ports of cores 2 and 3 in tile 502 can be configured using configuration 510B. Cores 0 to 3 can include switch devices with ports that can be configured using the configurations as to inter-tile or intra-tile direction of data receipt or inter-tile or intra-tile direction of data forwarding. Switches (e.g., SW0 to SW3 in tile 504A and SW4-SW7 in tile 504B) can be configured using configuration 520. Switches SW0 to SW7 can include ports that can be configured using the configurations as to inter-tile or intra-tile direction of data receipt or inter-tile or intra-tile direction of data forwarding. Likewise, cores 4 and 5 in tile 506 can be configured using configuration 530A whereas cores 6 and 7 in tile 506 can be configured using configuration 530B. Cores 4 to 7 can include switch devices with ports that can be configured using the configurations as to inter-tile or intra-tile direction of data receipt or inter-tile or intra-tile direction of data forwarding. A tile can be part of a die or system-on-chip (SoC) in some examples.

Note that in some examples, inter-tile transfer is made in the (+) X or (−) X direction to a core or switch in a same relative position. For example, core 0 could make an inter-tile transfer of data to switch SW0 or switch SW0 can make an inter-tile transfer to core 0. Similarly, core 1 could make an inter-tile transfer of data to switch SW1 or switch SW1 can make an inter-tile transfer to core 1. Core 2 could make an inter-tile transfer of data to switch SW2 or switch SW2 can make an inter-tile transfer to core 2. Core 3 could make an inter-tile transfer of data to switch SW3 or switch SW3 can make an inter-tile transfer to core 3.

For example, switch SW0 could make an inter-tile transfer of data to switch SW4 or switch SW4 can make an inter-tile transfer to switch SW0. Similarly, switch SW1 could make an inter-tile transfer of data to switch SW5 or switch SW5 can make an inter-tile transfer to switch SW1. Switch SW2 could make an inter-tile transfer of data to switch SW6 or switch SW6 can make an inter-tile transfer to switch SW2. Switch SW3 could make an inter-tile transfer of data to switch SW7 or switch SW7 can make an inter-tile transfer to SW3.

For example, switch SW4 could make an inter-tile transfer of data to core 4 or core 4 can make an inter-tile transfer to switch SW4. Similarly, switch SW5 could make an inter-tile transfer of data to core 5 or core 5 can make an inter-tile transfer to switch SW5. Switch SW6 could make an inter-tile transfer of data to core 6 or core 6 can make an inter-tile transfer to switch SW6. Switch SW7 could make an inter-tile transfer of data to core 7 or core 7 can make an inter-tile transfer to switch SW7.

In the example of FIG. 5, use of configurations 510A, 510B, 520, 530A, and 530B cause transfer of data (labeled as “A”) originating from a CCE (not shown) in core 0 to cores 1, 2, and 3, to switch SW0, to switch SW4, and to core 4. Note that the reference to data can also refer to a packet or message with a data, header, and meta-data. Based on configuration 510A, core 0's switch (not shown) forwards the data to cores 1-3 in its tile 502 and SW0 in neighboring tile 504A. Based on configuration 520, switch SW0 sends the data to SW4 in neighboring tile 504B and switch SW4 sends the data to core 4 in neighboring tile 506. Within tile 506, based on configuration 530A, core 4's switch sends the data to core 4's local CCE and to other cores (cores 5-7).

Description next turns to a more specific description of an example of use of bit vectors to program operations of cores and switches to transfer data in cycles 0 to 6. Configurations 510A and 510B can be used in cycle 0, configuration 520 can be used in cycles 1-4, and configurations 530A and 530B can be used in cycles 5 and 6. Configuration register values can indicate propagation directions for a message received by a port. In cycle 0, vectors I₂, I₃, I₄, I₅, and I₇ are used to program operation of cores 0 to 3.

I₇ bit vector indicates core 0 is to originate data A from its data pipeline and CCE. I₇ bit vector represents an input to port 7. In this example, data A is received into local input port I₇ of core 0 (not directional). For data received at I₇, configuration register values indicates data propagation as follows:

[0, 0, 1 (X direction to core 1), 1 (Y direction to core 2), 1 (diagonal direction to core 3), 1 (inter-tile to switch 0), 0,0,0,0,0]. Core 2 receives data at its port i3 (y direction port), Core 3 receives data at its port i4 (diagonal port), and Core 1 receives data at its port i2 (x direction port). In this example, ports 0, 1, and 6 are not used by core 0 and consequently, i0, i1, and i6 are all zeros in this example and are not shown in FIG. 5.

I₂ bit vector indicates core 1 is to receive data intra-tile in the X direction from core 0. I₃ bit vector indicates core 2 is to receive data intra-tile in the Y direction from core 0. I₄ bit vector indicates core 3 is to receive data intra-tile in a diagonal direction from core 0. I₅ bit vector indicates core 0 is to transmit data or message an inter-tile from tile 502 to neighboring tile 504A, specifically to a corresponding position switch SW0 (bottom left) in the neighboring tile 504A.

Referring to cycles 1 and 2, I₆ bit vector indicates data originates (−) X direction from core 0 to switch SW0. I₅ bit vector indicates SW0 is to transmit data or message an inter-tile to neighboring tile 504B, specifically to a corresponding position switch SW4 (bottom left) in the neighboring tile 504A.

Referring to cycles 3 and 4, I₆ bit vector indicates switch SW4 receives data originating in (−) X direction from SW0. I₅ bit vector indicates SW4 is to transmit data or message an inter-tile to neighboring tile 506, specifically to a corresponding position core 4 (bottom left) in the neighboring tile 506.

In cycle 5, I₆ bit vector indicates core 4 receives data originating in the (−) X direction from switch SW4. Next, in cycle 6, based on I₇ bit vector, core 4 transmits the data to cores 5, 6, and 7 based on respective bit vectors I₂, I₃, and I₄.

In this example, propagation of a message originating from a core to another cores takes no more than four switch hops. Note that these configurations can be reduced to include only a subset of cores on the die or expanded to other die in the system via the HSIO ports connected to switches SW0 to SW7.

Discovery of Routes from Root Switch to Terminal Switches

As described earlier, registers of specific switches are configured with information about port directions to transmit collective communications (CC) along a route from sender to receiver. For switches participating in the CC pattern (e.g., all-reduce, reduce, scatter, all-gather, barrier, or others), one root port and zero or more designated ports are to be configured. A designated port can be connected to a terminal switch or, via one or more switches, to a terminal switch. Depending on the direction (from or to the root switch), a data broadcast or an arithmetic operation can be executed within the switches.

Various examples provide for the automatic detection and configuration of CC topologies of switches in a NoC. Various examples utilize an autoconfiguration message to discover a route from a root switch, through forwarding switches, to terminal switches. Route discovery can utilize a per-switch Finite State Machine (FSM) and a per-port FSM. Routing of CC between terminal switches and a root switch can be formulated as a Steiner Arborescence (SA) problem of: given the root of the tree r, a network topology graph G=(V, E), where V and E are respectively the vertices and edges of a graph, and a set of terminals S⊂V find a Steiner Arborescence that connects r with all terminals in S. In other words, a Steiner Arborescence is a directed, spanning tree that connects only selected terminal switches (e.g., switches directly connected to cores), forwarding switches, and a root switch.

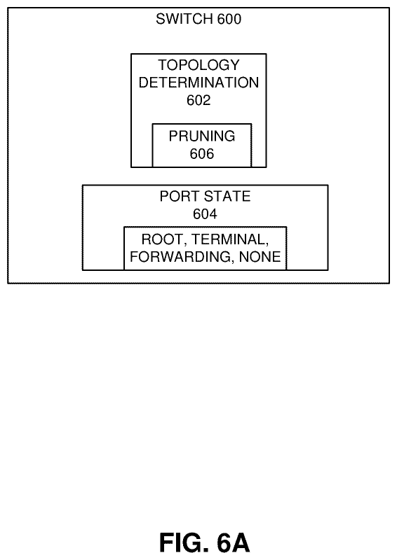

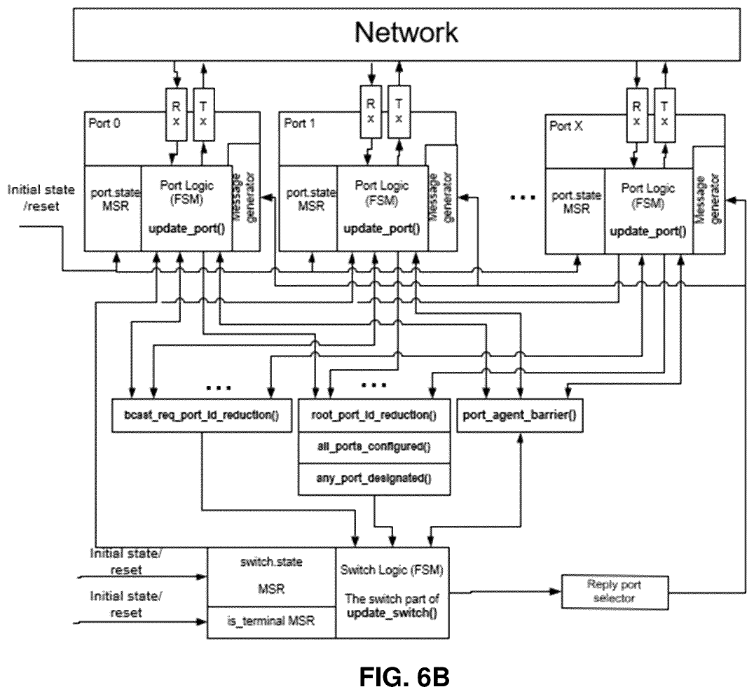

FIG. 6A depicts an example circuitry of a switch. Switch 600 can include circuitry to determine a port connected to a port of a terminal switch; a port of a forwarding switch; a port of a root switch; or a port of a switch that is not a terminal switch, not a forwarding switch, and not a root switch. Terminal switches are switches directly connected to cores and the cores perform computation on data and distribute data using collective communications. Terminal switches can perform summation of packet data with other packet data from other workers, multiplication, division, minimum, maximum, or other data computation operations related to barrier, reduce, AllReduce, ReduceScatter, AllGather, or others.

Barrier (e.g., MPI_Barrier) can represent a single-bit exchange between all processes within a group and a parallel programming scenario in which a process cannot proceed until all processes reach a synchronization point in a program. Reduce can reduce the elements of an array into a single result. For example, a single-thread reduce takes an array and reduces it to a scalar. In the collectives context, reduce takes a single array from each terminal, and reduces elementwise, storing the resulting array in the root. AllReduce (e.g., MPI_Allreduce) can include collecting data from different processing units and combining the data into a result such as element-wise reduction, using operators such as addition or Boolean logic, in which all processes synchronize private data into a common state. ReduceScatter can reduce input values across ranks, with each rank receiving a subpart of the result. AllGather can aggregate A values into an output of dimension A*B, where B is an integer. Collective communications can be transmitted from terminal switches to the root switch and back to terminal switches.

Topology determination 602 can discover a shortest and fastest path from a root switch to terminal switches via forwarding switches by a race of autoconfiguration broadcast messages from a root switch to terminal switches, as described herein. Topology determination 602 can perform pruning 606 to remove switches from a tree that are not a terminal switch, not connected to a terminal switch, and not connected to a root switch.

Port state 604 can indicate a state of a port as a root port, connected to a root port, a terminal port, connected to a terminal port, a forwarding port, connected to a forwarding port, or none. Discovery of a state of a port can occur by configuration of switch 600 or broadcasting states of a switch port (e.g., terminal, forwarding, root) to switch 600 and updating port state 604, as described herein.

FIG. 6B depicts an example circuitry in a switch. As described herein, ports 0 to X, where X is an integer, can receive an autoconfiguration message at an update cycle and FSM can update per-port and per-switch states. For bidirectional ports 0 to X, in a manner described herein, per-port state FSM can be utilized to determine a port state. A port state can identify whether the port is connected to a terminal switch port, a forwarding switch port, a root switch port, or none. States of ports of a switch may be processed in parallel. Propagation of switch state can follow a fastest or shortest path and identify a fastest or shortest path between terminal switches and the root switch.

Before determining a port state using operations described herein, a reset procedure can be performed to wait until any pending in-network collective traffic is completed, including a previous autoconfiguration, writing PortStates.IDLE state value to MSRs of port FSMs of switches, and writing SwitchStates.IDLE state value to MSRs of all switch FSMs. An example reset procedure can be as follows. The lack of configuration messages in the network can guarantee that the IDLE state is stable during the reset procedure. At (1), if switches are in SwitchStates.IDLE, SwitchStates.CONFIGURED, or SwitchStates.REJECTED states, ports may not generate configuration messages when entering the PortStates.IDLE state and because switch FSMs retain their states if they lack incoming MessageStates.BROADCAST_REQUEST message.

At (2), if a switch is to be treated as a terminal switch, is_terminal is set to ‘1’. At (3), when a logical separation of links is to occur or ports are unconnected to ports of other switches, such ports can be marked as PortStates.DISABLED. A CC runtime (e.g., MPI), orchestrator, or administrator can configure is_terminal and PortStates.DISABLED in per-switch registers.

An example autoconfiguration procedure to configure port states and determine a route from route switch to terminal switches can be as follows. At (1), software (e.g., MPI run time) running on terminals or cores performs a single write to a selected root switch switch.state register (e.g., MSR) with a SwitchStates.INITIATE_AUTOCONFIGURATION state. In response, the root switch enters a SwitchStates.BROADCASTING mode and sends an autoconfiguration broadcast message MessageStates.BROADCAST_REQUEST on non-disabled ports to ports of other switches. An MPI runtime can launch and manage individual processes that make up an MPI application for processes to exchange data via messages, including point-to-point and collective communication operations.

At (2), other switches start in SwitchStates.IDLE state and ports in PortStates.IDLE, and check for incoming autoconfiguration messages. Based on receipt of MessageStates.BROADCAST_REQUEST message, a port enters PortStates.ROOT state, marking the ingress/egress port that received autoconfiguration broadcast message as the root port. The switch enters SwitchStates.BROADCASTING state and sends an autoconfiguration broadcast message on other non-disabled ports other than the root port.

At (3), if a switch is in a SwitchStates.BROADCASTING state and a MessageStates.BROADCAST_REQUEST message is received on a port, such port rejects the request by sending a MessageStates.BROADCAST_RESPONSE_REJECT message on the inbound port. At (4), if a port receives a MessageStates.BROADCAST_RESPONSE_REJECT message, such port enters PortStates.REJECTED state and responds with MessageStates.BROADCAST_RESPONSE_REJECT to MessageStates.BROADCAST messages.

At (5), if a switch is not in a SwitchStates.BROADCASTING state and a MessageStates.BROADCAST_REQUEST message is received on a port, the switch sends MessageStates.BROADCAST_RESPONSE_ACCEPT message. If a port receives a MessageStates.BROADCAST_RESPONSE_ACCEPT message, such port enters the PortStates.DESIGNATED_PORT state, marking the port as a designated port (e.g., connected to a terminal or core) and indicates a viable branch of the tree (e.g., arborescence or directed tree).

At (6), a switch is configured once its ports enter a state other than PortStates.IDLE. This activates the all_ports_configured reduction signal. If a switch is configured (all_ports_configured==1), has at least one designated port, or is marked as a terminal switch, a MessageStates.BROADCAST_RESPONSE_ACCEPT message can be sent on the port connected directly or indirectly to the root switch (e.g., root port), and the switch can enter SwitchState.CONFIGURED state. However, at (7), if a switch is configured but is neither a terminal switch nor has designated such ports, a switch can send MessageStates.BROADCAST_RESPONSE_REJECT message on the root port, indicating that it does not lead to any terminal switches and that the sub-network is to be pruned from the tree.

At (8), the network is fully configured once the root switch enters the SwitchState.CONFIGURED. An administrator, MPI runtime, or orchestrator software may periodically poll the root switch switch.state MSR for indication of the autoconfiguration completion. Once the root switch is configured, an in-network CC agent may use the port.state values to direct CC synchronization.

Referring to FIG. 6B, to perform an autoconfiguration procedure, switch logic FSM can read local MSRs that include the current state, switch.state, and is_terminal, and reduced signals from port logic bcast_req_port_id_reduction, root_port_id_reduction, all_ports_configured, and any_ports_designated. For ports 0 to X, an (X+1)-way synchronization barrier, port_agent_barrier( ) can be maintained. Various port logic are described in Table 4 below.

TABLE 4

| Circuitry | Example operation |
|---|---|
| bcast_req_port_id_reduction( ) | A one-of-many broadcast signal that maps the current message |
| | states into an inbound port ID. In case of multiple broadcast |
| | messages incoming at the same update round, select the lowest |
| | port ID. |
| root_port_id_reduction( ) | One-of-many signal that broadcasts the root port ID from port |

The root port is the port with

| | |
|---|---|
| | FSMs to switch FSM. The root port is the port with |
| | PortStates.ROOT_PORT state. |
| all_ports_configured( ) | Signals ‘1’ if ports are in states other than PortStates. IDLE. |
| any_port_designated( ) | Signals ‘1’ if any port is in PortStates.DESIGNATED_PORT |
| reply_port_selector( ) | Propagates a MessageStates from a switch FSM to a selected |
| | port message generator and MessageStates.NO_MESSAGE to |
| | other ports. |

To identify root or forwarding ports and prune non-terminal ports, port logic FSM can perform operations of Pseudocode 1 and Pseudocode 2. Pseudocode 1 can access per-port states for each update round and evaluate signals, bcast_req_port_id, root_port_id, all_ports_configured, and any_port_designated. For Pseudocode 2, a port can access the beast_req_port_id signal representing a port that obtained the BROADCAST_REQUEST message in the current update round and the port accesses the current per-switch state.

```
Pseudocode 1
  def update_switch(switch):
  # Per-port reduction signals. Select only one of the ports that received a BROADCAST
  # message. Assume proper synchronization of bcast_req_port_id before
  # the dependent logic progresses.
  bcast_req_port_id = switch.bcast_req_port_id_reduction( )
  # Per-port logic. This can be executed in parallel for every port agent independently.
  for port_id in range(switch.num_ports):
    port = switch.ports[port_id]
    # The switch state and synchronization signals must be visible to all ports.
    update_port(port, switch)
  # All port agents complete message handling before per-switch logic.
  # synchronization of per-port agents.
  switch.port_agent_barrier( )
  # Switch logic
  if switch.state == SwitchStates.INITIATE_AUTOCONFIGURATION:
    switch.state = SwitchStates.BROADCASTING
  else if switch.state == SwitchStates.IDLE and bcast_req_port_id != None:
    switch.state = SwitchStates.BROADCASTING
  else if switch.state == SwitchStates.BROADCASTING:
    # Once port updates happen, perform the current port state reduction to
    # update the switch state. This needs to happen at every cycle when the switch is in the
    # BROADCAST mode, but the related circuits can be disabled otherwise. Per-port reduction
    # signals.
    root_port_id = switch.root_port_id_reduction( )
    all_ports_configured = switch.all_ports_configured_reduction( )
    any_port_designated = switch.any_port_designated_reduction( )
    if all_ports_configured:
    if root_port_id is not None:
      root_port = switch.ports[root_port_id]
      if any_port_designated or switch.is_terminal:
      # accept the root port if this is a forwarding (has at least one
      # designated port) or if this is a terminal node.
      switch.state = SwitchStates.CONFIGURED
      root_port.send_message(MessageStates.BROADCAST_RESPONSE_ACCEPT)
      else:
      # Otherwise, perform pruning on the way back to the root.
      switch.state = SwitchStates.REJECTED
      root_port.state = PortStates.REJECTED
      root_port.send_message(MessageStates.BROADCAST_RESPONSE_REJECT)
    else:
      # Root received all responses.
      switch.state = SwitchStates.CONFIGURED
  else:
      # REJECTED and CONFIGURED are stable states. IDLE awaits the request message.
      pass
```

```
Pseudocode 2
def update_port(port, switch):
  if port.state != PortStates.DISABLED:
    # Read the message for the current port. Omit disabled ports.
    msg = port.receive_message( )
    bcast_req_port_id = switch.bcast_req_port_id_reduction( )
    if switch.state == SwitchStates.INITIATE_AUTOCONFIGURATION:
    # The initial (trigger) state for the root node. This state immediately
    # transition into broadcast mode after all ports and send a broadcast request message.
    port.send_message(MessageStates.BROADCAST_REQUEST)
    else if switch.state == SwitchStates.IDLE and bcast_req_port_id != None:
    # Switch is idle but at least one port received a broadcast request
    if port.local_port_id == bcast_req_port_id:
      # If the current port received a BROADCAST_REQUEST and was selected for
acceptance,
      # update state and mark the port as ‘root port’ (uplink).
      port.state = PortStates.ROOT_PORT
    else if msg == MessageStates.NO_MESSAGE:
      # Other ports should respond with a BROADCAST request
      port.send_message(MessageStates.BROADCAST_REQUEST)
    else:
      # At this point, only a broadcast request message can be received. Reject other
      # requests.
      port.send_message(MessageStates.BROADCAST_RESPONSE_REJECT)
      port.state = PortStates.REJECTED
    else if switch.state == SwitchStates.BROADCASTING:
      if msg == MessageStates.BROADCAST_RESPONSE_ACCEPT:
          port.state = PortStates.DESIGNATED_PORT
        else if msg == MessageStates.BROADCAST_RESPONSE_REJECT:
          port.state = PortStates.REJECTED
        else if msg == MessageStates.BROADCAST_REQUEST:
          port.send_message(MessageStates.BROADCAST_RESPONSE_REJECT)
      else if switch.state in [SwitchStates.CONFIGURED,
SwitchStates.INITIATE_AUTOCONFIGURATION]:
        if msg == MessageStates.BROADCAST_RESPONSE_ACCEPT:
          port.state = PortStates.DESIGNATED_PORT
        else if msg == MessageStates.BROADCAST_REQUEST:
          port.send_message(MessageStates.BROADCAST_RESPONSE_REJECT)
      else if switch.state == SwitchStates.REJECTED:
        # A hazard may appear if both switches send a BROADCAST simultaneously. The switch
        # might already have received the reject response but not the broadcast request from
        # the peer. If the current switch is in the REJECTED mode, then it leads to no viable
        # terminals anyway, so there is no point in accepting the delayed request.
        if msg == MessageStates.BROADCAST_REQUEST:
          port.send_message(MessageStates.BROADCAST_RESPONSE_REJECT)
```

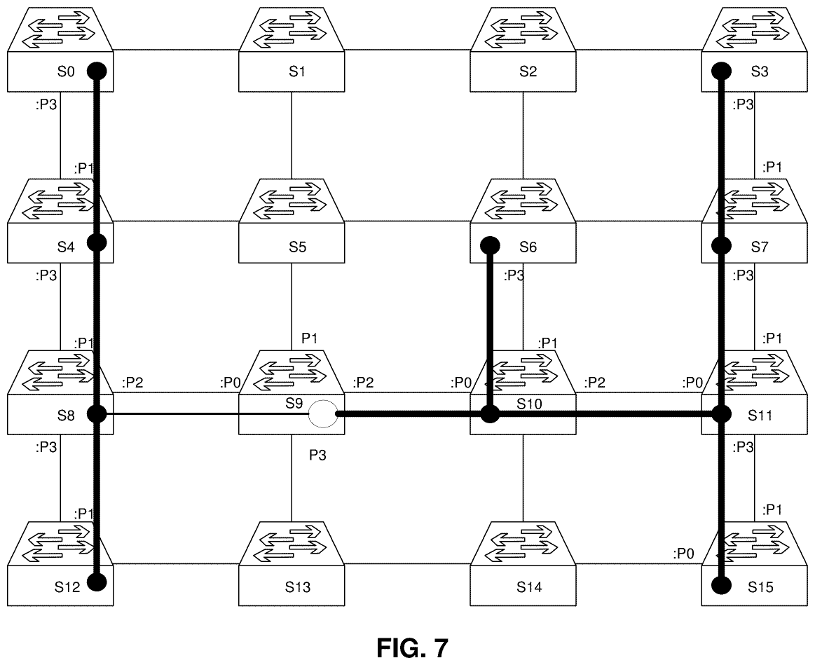

FIG. 7 depicts an example of topology discovery. In this example, S9 is designated as the root switch of collective operations; S4, S7, and S11 are forwarding switches; and switches S0, S3, S6, S8, S10, S12, and S15 are designated terminal switches to be connected. Switches S1, S2, S5, S13, and S14 are not terminal switches and are not forwarding switches and do not participate in collective communications and do not forward messages.

An example manner of route discovery follows. At (1), root switch S9 can broadcast a root port switch state on ports P0, P1, P2, and P3 to respective port P2 of switch S8, port P3 of switch S5, port P0 of switch S10, and port P1 of switch S13 and those ports of switches S8, S5, S10, and S13 can identify ports of switch S9 as root ports as those ports are connected to a root switch, either directly or indirectly through another switch. At (2), at least partially in parallel, ports P1 and P3 of switch S8 can indicate root port states by broadcast to ports P3 and P1 of respective switches S4 and S12; ports P0, P1, and P2 of switch S5 can indicate root port states by broadcast to ports P3, P2, and P0 of respective switches S1, S4, and S6; ports P1, P2, and P3 of switch S10 can indicate root port states by broadcast to ports P3, P0, and P1 of respective switches S6, S11, and S14; and ports P0 and P2 of switch S13 can identify root port states to ports P2 and P0 of respective switches S12 and S14. Those ports of switches S1, S4, S6, S11, S12, and S14 can identify root port state.

At (3), at least partially in parallel, ports P1 and P2 of switch S4 can indicate root port states by broadcast to ports P3 and P0 of respective switches S0 and S5; ports P0 and P2 of switch S1 can indicate root port states by broadcast to ports P2 and P0 of respective switches S0 and S2; ports P0 and P2 of switch S13 can indicate root port states by broadcast to ports P2 and P0 of respective switches S12 and S14; ports P0 and P2 of switch S14 can identify root port states to ports P2 and P0 of respective switches S13 and S15; and ports P0, P1, and P2 of switch S6 can identify root port states to ports P2, P3, and P0 of respective switches S5, S2, and S7.

At (4), at least partially in parallel, ports P0 and P2 of switch S2 can indicate root port states by broadcast to ports P2 and P0 of respective switches S1 and S3; ports P1 and P3 of switch S7 can indicate root port states by broadcast to ports P3 and P1 of respective switches S3 and S11; and ports P0 and P2 of switch S14 can indicate root port states by broadcast to ports P2 and P0 of respective switches S13 and S15.

At (5), switches S0, S3, S6, S8, S10, S12, and S15 can identify as connected to terminals and have received signals indicating connection to a root switch.

At (6), switches that are not connected to a terminal switch or connected to a least number of terminal switches can identify to the root switch and the root switch can prune those switches from the topology. For example, switches S1, S2, S5, S13, and S14 are not connected to a terminal switch and are not on a shortest route in terms of number of switch hops between a root switch and terminal switch. For example, a path from root switch S9 to terminal switch S0 need not traverse switches S5 and S1 as a path from through switch S8, S4, and S0 connects two terminal switches and root switch. Accordingly, a topology can include root switch S9, forwarding switches S4, S7, and S11, and terminal switches S0, S3, S6, S8, S10, S12, and S15.

While a grid topology is shown, other topologies can be used such as: point-to-point, bus, star, ring, star, crossbar, circular, mesh, tree, hybrid, torus, or daisy chain.

Assuming a 2.933 GHz memory frequency, a 4 cycles per hop penalty, and log₂(V) hops, the configuration time for a V=4⁷ (10⁴-scale) hypercube could be:

$${T}_{hypercube} = \frac{6232 + 4 {log}_{2} ( 16384 )}{2.933 GHz} = 2.1 us$$

Table 5 presents an example of configuration times in network cycles as a function of network class, size, and latency variance. In this case, jitter is modeled as a zero-mean Gaussian distribution, with the jitter value either speeding up or slowing down individual messages to imitate the network's behavior under light traffic.

TABLE 5

| | Network size (V) | | | | | | | |
|---|---|---|---|---|---|---|---|---|
| | 10e1 | | 10e2 | | 10e3 | | 10e4 | |
| Topology | No | 20% | No | 20% | No | 20% | No | 20% |
| class | jitter | jitter | jitter | jitter | jitter | jitter | jitter | jitter |
| 2D Mesh | 328 | 280 | 1096 | 920 | 3848 | 3096 | 13000 | 10320 |
| 3D Mesh | 344 | 304 | 728 | 536 | 1640 | 1248 | 3944 | 2960 |
| Hypercube | 296 | 256 | 824 | 744 | 2040 | 1912 | 6232 | 6248 |
| Hyper-X | 200 | 200 | 296 | 280 | 640 | 640 | 1232 | 1272 |
| Fat-Tree | 184 | 168 | 792 | 744 | 2200 | 2072 | 5368 | 5152 |
| Internet | 112 | 96 | 280 | 240 | 2760 | 2880 | 7072 | 7816 |
| AS | | | | | | | | |

Table 6 shows configuration times in network cycles for different topologies and network sizes and a comparison with the default root (node 0) and a random node selected as a root. Depending on the network class, the root selection may impact the arborescence diameter and, therefore, the configuration time.

TABLE 6

| | Network size (V) | | | | | | | |
|---|---|---|---|---|---|---|---|---|
| | 10e1 | | 10e2 | | 10e3 | | 10e4 | |
| Topology | de- | ran- | de- | ran- | de- | ran- | de- | ran- |
| class | fault | dom | fault | dom | fault | dom | fault | dom |
| 2D Mesh | 328 | 280 | 1096 | 984 | 3848 | 2888 | 13000 | 9544 |
| 3D Mesh | 344 | 344 | 728 | 632 | 1640 | 1192 | 3944 | 3128 |
| Hypercube | 296 | 296 | 824 | 824 | 2040 | 2040 | 6232 | 6232 |
| Hyper-X | 200 | 248 | 296 | 296 | 640 | 688 | 1232 | 1280 |
| Fat-Tree | 184 | 232 | 792 | 840 | 2200 | 2152 | 5368 | 5320 |
| Internet | 112 | 160 | 280 | 280 | 2760 | 3168 | 7072 | 7472 |
| AS | | | | | | | | |

Table 7 shows a comparison of configuration times when the number of terminals is changed. Because the configuration must reach every node in the network, regardless of the number of terminals to be connected, there is no difference in the number of messages.

TABLE 7

| | Network size (V) | | | | | | | |
|---|---|---|---|---|---|---|---|---|
| | 10e1 | | 10e2 | | 10e3 | | 10e4 | |
| | de- | ran- | de- | ran- | de- | ran- | de- | ran- |
| Topology | fault | dom | fault | dom | fault | dom | fault | dom |
| class | (50%) | 10% | (50%) | 10% | (50%) | 10% | (50%) | 10% |
| 2D Mesh | 328 | 328 | 1096 | 1096 | 3848 | 3848 | 13000 | 13000 |
| 3D Mesh | 344 | 344 | 728 | 728 | 1640 | 1640 | 3944 | 3944 |
| Hypercube | 296 | 296 | 824 | 824 | 2040 | 2040 | 6232 | 6232 |
| Hyper-X | 200 | 200 | 296 | 296 | 640 | 640 | 1232 | 1232 |
| Fat-Tree | 184 | 184 | 792 | 792 | 2200 | 2200 | 5368 | 5368 |
| Internet AS | 112 | 112 | 280 | 280 | 2760 | 2760 | 7072 | 7072 |

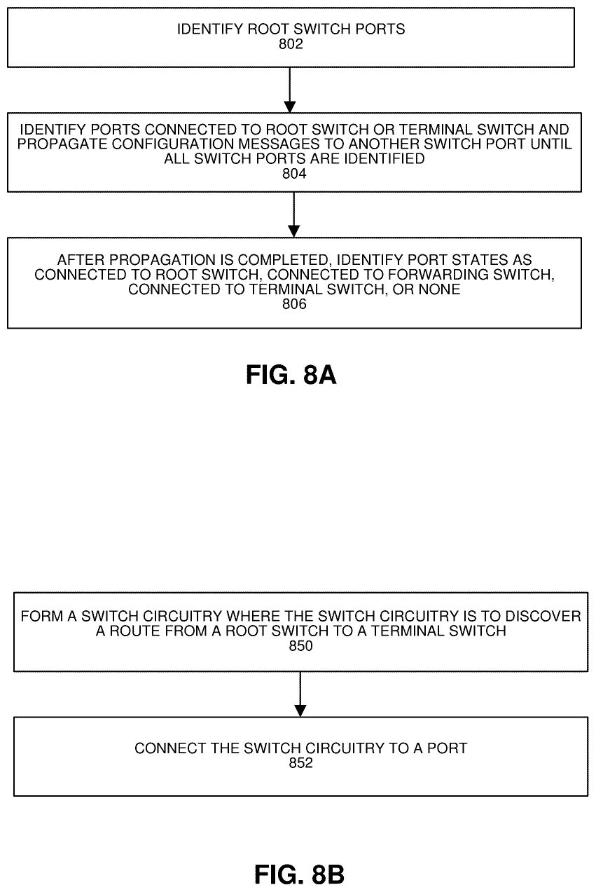

FIG. 8A depicts an example process. At 802, a root switch can transmit configuration messages from the root switch ports to ports of switches. The root switch can transmit configuration messages to switches that are one hop away from the root switch. At 804, the switches that receive the configuration messages can identify ports that receive the configuration messages as being connected to a root switch. Where a switch that receives a configuration message is connected to a terminal, the switch can propagate a message to the root switch identifying such switch as connected to a terminal. In addition, the switches that receive the configuration messages can propagate the configuration messages to other switches. The operation of 804 can repeat until switches in the network are identified as connected to a root switch, connected to a terminal, a forwarding switching, or none. At 806, after propagation of the configuration messages has reached all switches in the network, the root switch can prune switches from a topology that are identified as none (e.g., not connected to a root switch, not connected to a terminal, and not a forwarding switching) and identify switches in routes that connect the root switch to terminal switches. In some examples, switches prune themselves in a backpropagation path by sending MessageStates.BROADCAST_RESPONSE_REJECT on their root ports and other switches, including the root switch, exclude the ports where the rejection message was received from CC topology.

Accordingly, communications such as CC can be propagated from terminal switches to the root switch for collective operations and the root switch can transmit communications to the terminals switches using the switch routes.

Various examples need not access memory for configuration communications as communication can occur via switch communication queues and can be discarded after their state is identified at the peer switch. Computation can be reduced due to the lack of remote communication between core and memory, involving load/store type instructions, the use of hardware queues, and available network latency information (effective packet traversal time).

FIG. 8B depicts an example process. The process can be performed to form a switch. At 850, a switch circuitry can be formed. Various examples of switch circuitry are described herein. In some examples, the switch circuitry is configured to discover a shortest route from a root switch to one or more terminal switches by propagation of configuration messages that cause identification of port connections of the switch that receives the configuration message. Identification of port connections can include: connection to a terminal switch; connection to a forwarding switch; connection to a root switch; or not connected to a terminal switch, root switch, and a forwarding switch. At 852, the switch circuitry can be connected to one or more ports. The ports can connect to one or more ports of switches of the NoC.

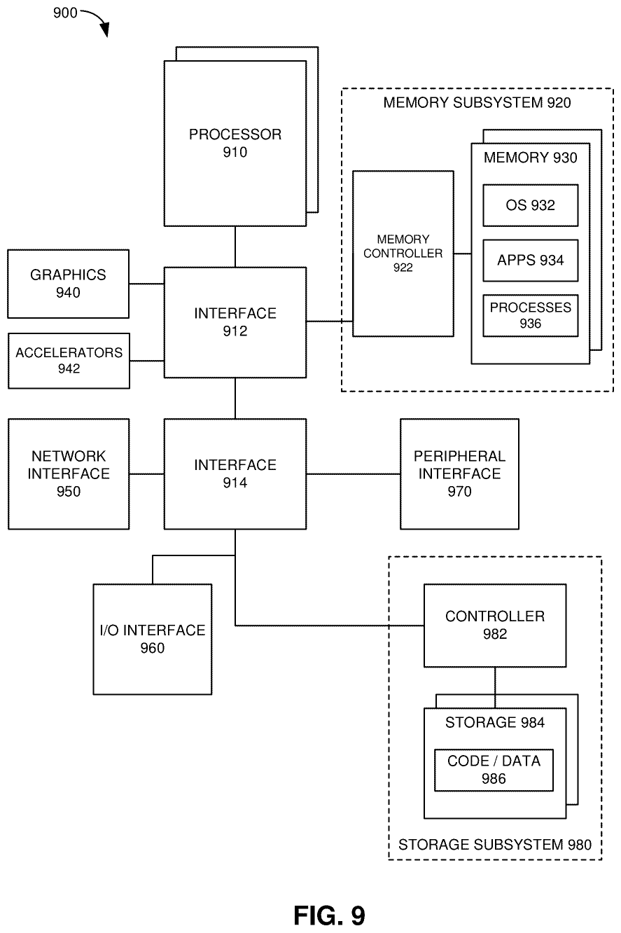

FIG. 9 depicts a system. Components of system 900 (e.g., processor 910, network interface 950, and so forth) to broadcast data or messages through one or more switches, as described herein. System 900 includes processor 910, which provides processing, operation management, and execution of instructions for system 900. Processor 910 can include any type of microprocessor, central processing unit (CPU), graphics processing unit (GPU), XPU, processing core, or other processing hardware to provide processing for system 900, or a combination of processors. An XPU can include one or more of: a CPU, a graphics processing unit (GPU), general purpose GPU (GPGPU), and/or other processing units (e.g., accelerators or programmable or fixed function FPGAs). Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a display that provides an output to a user. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a programmable or fixed function offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 and/or processes 936 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 932 or driver can advertise capability of network interface device 950 or other processor-executed processes to perform processing of HTTP headers in user space without copying HTTP payloads to user space and can form a packet with processed HTTP headers and HTTP payloads in kernel space and/or update headers of a packet without providing the received packet for reliable data transmission protocol processing except for connection termination packet. In some examples, OS 932 or driver can enable or disable use of network interface device 950 or other processor-executed processes to perform processing of HTTP headers in user space without copying HTTP payloads to user space and can form a packet with processed HTTP headers and HTTP payloads in kernel space and/or update headers of a packet without providing the received packet for reliable data transmission protocol processing except for connection termination packet.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. In some examples, packet processing device or network interface device 950 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 900 includes one or more input/output (I/O) interface(s) 960. I/O interface 960 can include one or more interface components through which a user interacts with system 900. Peripheral interface 970 can include any hardware interface not specifically mentioned above. Peripherals refer generally to devices that connect dependently to system 900.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. A non-volatile memory (NVM) device is a memory whose state is determinate even if power is interrupted to the device.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 900 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and includes a method that includes: in a network of switches: configuring a shortest route from a root switch to one or more terminal switches of the network by: the root switch causing: identification of switches of the network as one of: a terminal switch, a forwarding switch, or a root switch, wherein: the terminal switch is connected to a processor and the processor is to process collective communications.

Example 2 includes one or more examples, wherein the configuring the shortest route from the root switch to one or more terminal switches of the network comprises: causing ports of the switches of the network to identify a connection to another port as one of: connection to a terminal switch; connection to a forwarding switch; connection to a root switch; and not connected to a terminal switch, root switch, and a forwarding switch.

Example 3 includes one or more examples, wherein the configuring the shortest route from the root switch to one or more terminal switches of the network comprises: blocking communication to switches of the network that are not connected to a terminal switch and not connected to a forwarding switch.

Example 4 includes one or more examples, wherein the collective communications comprise Message Passing Interface (MPI) collective communications (CC), Symmetric Hierarchical Memory Access (SHMEM) communications, or Unified Parallel C (UPC) communications.

Example 5 includes one or more examples, wherein the MPI CC comprise at least one of MPI Barrier, MPI Reduce, MPI Broadcast, or MPI AllReduce.

Example 6 includes one or more examples, wherein the configuring the shortest route from the root switch to one or more terminal switches of the network comprises determining a Steiner Arborescence that connects terminal switches, forwarding switches, and a root switch.

Example 7 includes one or more examples, and includes an apparatus comprising: a first switch system on chip (SoC) circuitry comprising: circuitry to: transmit a request to a second switch, wherein the request is to cause identification, to the first switch, of a switch port connected to a core, and wherein a switch that receives the request is to propagate the request to another switch and determine a route from the first switch to the switch port connected to the core based on the identification, wherein switches of a network are configured to transmit collective communications along the route.

Example 8 includes one or more examples, wherein the route comprises a mapping of egress and ingress ports of the switches of the network.

Example 9 includes one or more examples, wherein the request is to cause identification, to the first switch, of the switch port connected to the core is to cause: ports of the switches of the network to identify a connection to another port as connection to one of: a terminal switch; a forwarding switch; a root switch; and not connected to the root switch, not connected to a terminal switch, and not connected to a forwarding switch.

Example 10 includes one or more examples, wherein the circuitry is to determine the route by pruning a switch that is not connected to the root switch, not connected to a terminal switch, and not connected to a forwarding switch.

Example 11 includes one or more examples, wherein the route comprises a shortest route from the root switch to one or more terminal switches.

Example 12 includes one or more examples, wherein the determine the route from the first switch to the switch port connected to the core based on the identification comprises determine a Steiner Arborescence that connects selected terminal switches, forwarding switches, and a root switch.

Example 13 includes one or more examples, wherein the collective communications comprise Message Passing Interface (MPI) collective communications (CC), Symmetric Hierarchical Memory Access (SHMEM) communications, or Unified Parallel C (UPC) communications.

Example 14 includes one or more examples, wherein the MPI CC comprise at least one of MPI Barrier, MPI Reduce, MPI Broadcast, or MPI AllReduce.

Example 15 includes one or more examples, and includes a process of making a switch comprising: connecting a switch system on chip (SoC) to a port, wherein the SoC is to discover a route from a root switch to a terminal switch in a network by determining a Steiner Arborescence tree that connects the terminal switch, a forwarding switch, and the root switch.

Example 16 includes one or more examples, wherein the discovery of the route comprises pruning a switch that is not connected to the root switch, not connected to a terminal switch, and not connected to a forwarding switch.

Example 17 includes one or more examples, wherein the route comprises a shortest route from the root switch to one or more terminal switches of the network.

Example 18 includes one or more examples, wherein the root switch receives and transmits collective communications comprising Message Passing Interface (MPI) collective communications (CC), Symmetric Hierarchical Memory Access (SHMEM) communications, or Unified Parallel C (UPC) communications.

Example 19 includes one or more examples, wherein the MPI CC comprise at least one of MPI Barrier, MPI Reduce, MPI Broadcast, or MPI AllReduce.

Example 20 includes one or more examples, wherein the route is based on register values programmed into switches of the network.

What is claimed is:

1. A method comprising:
in a network of switches:
configuring a shortest route from a root switch to one or more terminal switches of the network by:
the root switch causing:
identification of switches of the network as one of: a terminal switch, a forwarding switch, or a root switch, wherein:
the terminal switch is connected to a processor and
the processor is to process collective communications.

2. The method of claim 1, wherein the configuring the shortest route from the root switch to one or more terminal switches of the network comprises:
causing ports of the switches of the network to identify a connection to another port as one of: connection to a terminal switch; connection to a forwarding switch; connection to a root switch; and not connected to a terminal switch, root switch, and a forwarding switch.

3. The method of claim 1, wherein the configuring the shortest route from the root switch to one or more terminal switches of the network comprises:
blocking communication to switches of the network that are not connected to a terminal switch and not connected to a forwarding switch.

4. The method of claim 1, wherein the collective communications comprise Message Passing Interface (MPI) collective communications (CC), Symmetric Hierarchical Memory Access (SHMEM) communications, or Unified Parallel C (UPC) communications.

5. The method of claim 4, wherein the MPI CC comprise at least one of MPI Barrier, MPI Reduce, MPI Broadcast, or MPI AllReduce.

6. The method of claim 1, wherein the configuring the shortest route from the root switch to one or more terminal switches of the network comprises determining a Steiner Arborescence that connects terminal switches, forwarding switches, and a root switch.

7. An apparatus comprising:
a first switch system on chip (SoC) circuitry comprising:
circuitry to:
transmit a request to a second switch, wherein the request is to cause identification, to the first switch, of a switch port connected to a core, and wherein a switch that receives the request is to propagate the request to another switch and
determine a route from the first switch to the switch port connected to the core based on the identification, wherein switches of a network are configured to transmit collective communications along the route.

8. The apparatus of claim 7, wherein the route comprises a mapping of egress and ingress ports of the switches of the network.

9. The apparatus of claim 7, wherein the request is to cause identification, to the first switch, of the switch port connected to the core is to cause:
ports of the switches of the network to identify a connection to another port as connection to one of: a terminal switch; a forwarding switch; a root switch; and not connected to the root switch, not connected to a terminal switch, and not connected to a forwarding switch.

10. The apparatus of claim 7, wherein the circuitry is to determine the route by pruning a switch that is not connected to the root switch, not connected to a terminal switch, and not connected to a forwarding switch.

11. The apparatus of claim 7, wherein the route comprises a shortest route from the root switch to one or more terminal switches.

12. The apparatus of claim 7, wherein the determine the route from the first switch to the switch port connected to the core based on the identification comprises determine a Steiner Arborescence that connects selected terminal switches, forwarding switches, and a root switch.

13. The apparatus of claim 7, wherein the collective communications comprise Message Passing Interface (MPI) collective communications (CC), Symmetric Hierarchical Memory Access (SHMEM) communications, or Unified Parallel C (UPC) communications.

14. The apparatus of claim 13, wherein the MPI CC comprise at least one of MPI Barrier, MPI Reduce, MPI Broadcast, or MPI AllReduce.

15. A process of making a switch comprising:
connecting a switch system on chip (SoC) to a port, wherein the SoC is to discover a route from a root switch to a terminal switch in a network by determining a Steiner Arborescence tree that connects the terminal switch, a forwarding switch, and the root switch.

16. The process of claim 15, wherein the discovery of the route comprises pruning a switch that is not connected to the root switch, not connected to a terminal switch, and not connected to a forwarding switch.

17. The process of claim 15, wherein the route comprises a shortest route from the root switch to one or more terminal switches of the network.

18. The process of claim 15, wherein the root switch receives and transmits collective communications comprising Message Passing Interface (MPI) collective communications (CC), Symmetric Hierarchical Memory Access (SHMEM) communications, or Unified Parallel C (UPC) communications.

19. The process of claim 18, wherein the MPI CC comprise at least one of MPI Barrier, MPI Reduce, MPI Broadcast, or MPI AllReduce.

20. The process of claim 15, wherein the route is based on register values programmed into switches of the network.
